(19) United States
(12) Patent Application Publication
(10) Pub. No.: US 2008/0150195 A1
(43) Pub. Date: Jun. 26, 2008

(54) MULTI-LIVE FEED INJECTION MOLDING

(75) Inventor: GARRETT P. GARDNER, CORAL SPRINGS, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/614,613

(22) Filed: Dec. 21, 2006

(51) Int. Cl. B29C 45/46; B29C 45/03

(52) U.S. Cl. 264/328.17; 425/567; 425/562

(57) ABSTRACT

A plastic mold injection apparatus (300) is provided. The apparatus includes a runner system (110) that delivers a plastic melt through a flow tube (111), a cavity (120) that receives the plastic melt, and a hydraulic drive mechanism (130) that drives a pin in and out of a flow tube of the runner system. The runner system, the cavity, and the hydraulic drive mechanism are internal to, and operate within, the apparatus, to mix the plastic melt in the cavity. The hydraulic drive mechanism moves a first pin (141) out-of-phase with a second pin (142) to mix the plastic melt in the cavity. A first hydraulic pipe (151) removes hydraulic fluid to pull plastic melt into a first flow tube (111) from the cavity. A second hydraulic pipe (152) delivers hydraulic fluid to push out plastic melt from a second flow tube (112) to the cavity.

### FIELD OF THE INVENTION

The present invention relates to manufacture of mobile device plastics, and more particularly, to plastic mold injection.

### BACKGROUND

The demand for portable electronic devices and mobile devices has increased dramatically in recent years. Moreover, the aesthetic appeal of a mobile device is generally attributed to the design which can contribute to the demand. The material and construction of the design becomes more important as mobile devices become smaller and more compact. As one example, the plastic outside casing of mobile device should be resistant to breaking or cracks due to dropping or point impacts. The design that provides the strength should also be visually pleasing. The strength is generally attributed to the durability of the plastic housing and design of the mobile device.

Mobile devices generally include a plastic housing that can be manufactured using injection molding techniques. Injection molding is a process of filing a mold with molten plastic to produce an article of manufacture. Upon cooling, the hardened plastic can be removed from the mold to produce the article. Generally a single plastic melt is used to provide a contiguous material strength. In other molds, different plastics melts of varying strengths can be injected into the mold to produce a stronger article. The different plastic melts are generally introduced within a short time period of one another so as to properly bond together in the mold while heated. However, the integrity of the resulting article can be compromised due to the timing and delivery of the plastic melts.

Plastic injection molding techniques generally suffer from poor mechanical properties where two flow fronts join. A weld line is generally created at the location where the two flow fronts join due to the different mechanical properties of plastic. For example, a high temperature plastic melt may cool faster than a low temperature plastic melt. In such regard, the integrity of the bonding at the weld line is thus degraded, and the strength of the article is compromised. In another regard, the weld line introduces a visual anomaly in the plastic which can compromise the aesthetics of the design.

### SUMMARY

One embodiment is a plastic mold injection apparatus. The apparatus can include a runner system that delivers a plastic melt through at least one flow tube, a cavity directly coupled to the runner system that receives the plastic melt, and a drive mechanism that pushes and pulls at least one pin in and out of at least one flow tube of the runner system to mix the plastic melt in the cavity. In one arrangement, the runner system, the cavity, and the drive mechanism are integrated within the plastic mold injection apparatus. In another arrangement, the runner system, the cavity, and the drive mechanism are bored out within the mold to produce a single integrated mold.

A first embodiment is a plastic mold injection apparatus based on piston operation. The drive mechanism can include at least one piston that moves into and out of the drive mechanism, a drive shaft that receives the at least one piston, and at least one pin connected to the drive shaft. The at least one pin moves into and out of the at least one flow tube in accordance with a movement of the at least one piston into and out of the drive shaft. In one arrangement, a first piston can push a first pin in a first flow tube to push out the plastic melt through the first flow tube to the cavity, and a second piston can pull a second pin in a second flow tube to pull in the plastic melt from the cavity. The first piston and the second piston alternate between pushing and pulling such that the plastic melt moves into and out of the first flow tube and the second flow tube to mix the plastic melt in accordance with a first piston movement and a second piston movement.

A second embodiment is a plastic mold injection apparatus based on hydraulic operation. The apparatus can include a runner system that delivers a plastic melt through at least one flow tube, a cavity directly coupled to the runner system that receives the plastic melt, and a hydraulic operated drive mechanism integrated within the plastic mold injection apparatus that pushes and pulls at least one pin in and out of a flow tube of the runner system to mix the plastic melt in the cavity. The runner system, the cavity, and the hydraulic operated drive mechanism operate internal to the plastic mold injection apparatus. As one example, the mold can be bored out to include channels for the runner system within the mold that serve as conduits for delivering the plastic melt. The hydraulic operated drive mechanism can include a first drive shaft having a first hydraulic pipe for delivering hydraulic fluid and a second hydraulic pipe for removing hydraulic fluid, and a second drive shaft having a third hydraulic pipe for delivering hydraulic fluid and a fourth hydraulic pipe for removing hydraulic fluid. The first drive shaft can move a first pin in accordance with a flow of hydraulic fluid into the first drive shaft, and the second drive shaft can move a second pin in accordance with a flow of hydraulic fluid into the first drive shaft, such that the first pin moves out-of-phase with the second pin. The first pin can pull plastic melt from the cavity into a first flow tube during an ascending movement, and the second pin can push out plastic melt from a second flow tube during a descending movement to mix the plastic melt in the cavity.

One embodiment is a method for plastic mold injection. The method can include delivering a plastic melt through at least one flow tube of a runner system in a plastic mold injection apparatus, receiving the plastic melt in a cavity directly coupled to the runner system, wherein a shape of the cavity produces a plastic molded article, and pushing and pulling at least one pin in and out of a flow tube of the runner system to mix the plastic melt in the cavity using a hydraulic operated drive mechanism integrated within the plastic mold injection apparatus. The method can further include delivering hydraulic fluid using a first drive shaft having a first hydraulic pipe and removing hydraulic fluid through a second hydraulic pipe; and delivering hydraulic fluid using a second drive shaft having a third hydraulic pipe and removing hydraulic fluid through a fourth hydraulic pipe. The method can include, moving a first pin in accordance with a flow of hydraulic fluid into the first drive shaft, and moving a second pin in accordance with a flow of hydraulic fluid into the first drive shaft, such that the first pin moves out-of-phase with the second pin. The method can include pulling plastic melt in from the cavity into a first flow tube during an ascending movement, and pushing out plastic melt from a second flow tube during a descending movement to mix the plastic melt in the cavity.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a side view of a plastic injection mold having one piston to cause a pin to mix a plastic melt by pulling in and pushing out the plastic melt during a delivery of the plastic melt through a runner system in accordance with the embodiments of the invention;

FIG. 2 is a top view of the plastic injection mold of FIG. 1 showing a direction of movement of the piston in accordance with the embodiments of the invention;

FIG. 3 is a top view of a plastic mold having two pistons operating interchangeably to cause two pins to move out of phase with one another to mix a plastic melt in accordance with the embodiments of the invention;

FIG. 4 is a front view of the plastic mold of FIG. 3 illustrating how a motion of the pins pushes a plastic melt out of one flow tube and pulls the plastic melt into a second flow tube to mix the plastic melt in accordance with the embodiments of the invention;

FIG. 5 is an isometric view of the plastic mold of FIG. 3 illustrating the push and pull movement of the pistons to move two pins out-of-phase with one another to push-out and pull-in plastic melt in a first flow tube and a second flow tube to mix the plastic melt in accordance with the embodiments of the invention;

FIG. 6 is a top view of a plastic mold having two hydraulic drive shafts operating interchangeably to cause two pins to move out of phase with one another to mix a plastic melt in accordance with the embodiments of the invention;

FIG. 7 is a front view of the plastic mold of FIG. 6 illustrating how a motion of the pins pushes a plastic melt out of one flow tube and pulls the plastic melt into a second flow tube to mix the plastic melt in accordance with the embodiments of the invention; and

FIG. 8 is an isometric view of the plastic mold of FIG. 6 illustrating a synchronized delivery and removal of hydraulic fluid between a first drive shat and a second drive shaft to move two pins out-of-phase with one another to push out and pull in plastic melt in a first flow tube and a second flow tube to mix the plastic melt in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “directly coupled” can be defined as an integrated together. The term “injection molding” can be defined as a process of delivering plastic melt to a cavity in a mold, that is compatible with both thermoplastic and thermoset materials. The term “plastic melt” can be defined as molten plastic. The term “shot” can be defined as delivering a fixed amount of plastic melt to a cavity. The term “mold” can be defined as a device that includes a runner system for delivering a plastic melt and controlling the amount of plastic melt to a cavity in the mold that receives the plastic melt. The term “out of phase” can be defined as a first movement that is opposite in direction and/or magnitude to a second movement.

Briefly, injection molding is the process of injecting molten plastic within a cavity to produce an article. The heated plastic is forced under pressure into the cavity, which is created by parts of the mold that are clamped together. The cavity generally has an inverse shape to the desired article of manufacture. Upon cooling, the clamps of the mold can be released, and the solidified plastic can be removed. The resulting article is a single-piece finished part.

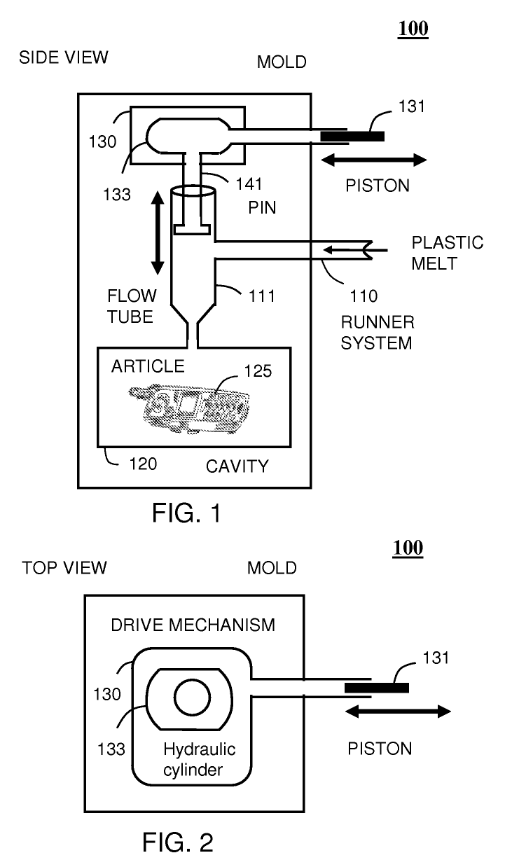

Referring to FIG. 1, a side view of a plastic mold injection apparatus 100, herein termed mold 100, in accordance with one embodiment of the invention is shown. Briefly, the mold 100 can be employed to produce an article. The article may be a plastic shell of a mobile device, such as a cell phone. The mold 100 can be integrated within a standard press to manufacture multiple articles. The mold 100 can include a runner system 110 that delivers a plastic melt through at least one flow tube 111, a cavity 120 directly coupled to the runner system that receives the plastic melt, and a drive mechanism 130 that pushes and pulls at least one pin 141 in and out of the flow tube 111 of the runner system. The runner system 110, the cavity 120, and the drive mechanism 130 can all be inside the mold 100.

In one arrangement, the drive mechanism 130 can be piston operated. The drive mechanism 130 can include a piston 131 that moves into and out of a drive shaft 133 connected to the pin 141. In one arrangement, the drive mechanism 130 is a hydraulic pump that moves the pin 141 up and down in accordance with a flow of hydraulic fluid into and out of the drive shaft 133. In one aspect, the piston 131 can be employed to actuate a movement of the pin 141 based on movement of hydraulic fluid into and out of the drive shaft 133. For example, the movement of the piston 131 can force hydraulic fluid to enter or exit the drive shaft 133, thereby causing the pin 141 to move up or down in the flow tube. When the diameter of the tube holding the piston 131 is larger that the diameter of the tube holding the pin 141, a small movement of the piston 131 creates a larger movement of the pin 141. Notably, the displacement of the pin 141 is a function of the diameter of the tube containing the piston 131 and the diameter of the tube containing the pin 141. In such regard, a movement of the piston 131 into and out of the drive shaft 133 can cause the pin 141 to move into and out of the flow tube 111 over a greater distance than the movement of the piston 131. The movement of the piston 131 can provide a pushing and a pulling of the pin 111 to mix the plastic melt in the cavity 120.

Briefly, the runner system 110 can deliver plastic melt to the cavity 120 to produce the article 125 of manufacture. As one example, the cavity may be the form of a mobile device housing, such that the article 125 produced is a plastic shell of a mobile device. Upon filling up the cavity, the piston 131 can be moved into and out of the drive shaft 133 to cause a movement of the pin 141 in the flow tube 111. In particular, a pulling out of the piston 131 causes the pin to ascend, thereby pulling in plastic melt from the cavity. Similarly, a pushing in of the piston 131 causes the pin to descend, thereby pushing plastic melt into the cavity. The process of moving the pin 141 up and down in the flow tube 111 causes the plastic melt to mix in the cavity. In one arrangement, the delivery of plastic melt can be pulsed in combination with the movement of the pins. For example, the runner system can adjust a pressure for delivering the plastic melt in accordance with the piston movement.

Referring to FIG. 2, a side view of the mold 100 is shown. The side view identifies the drive mechanism 130, the drive shaft 133, and the tube containing the piston 131. Again, the movement of the piston 131 into and out of the drive shaft can cause the pin 141 (See FIG. 1) to move up and down in the flow tube 111. In another aspect, the movement of the piston 131 into and out of the drive shaft 133 causes the pin 141 to ascend or descend in the cavity to mix the melt. The movement of the pin 141 causes a mixing of the plastic melt when the cavity 120 is filled. The mixing of the plastic melt reduces flow lines generally created upon cooling, and increases the strength of the resulting article 125. The piston can be moved in and out numerous times to mix the plastic melt. Moreover, a single inward or outward movement of the piston 131 may result in multiple cycling of the pin 141. That is, the pin 141 may move up and down, pulling in and pushing out plastic melt from the cavity, multiple times for each movement of the piston. In such regard, a movement of a piston 131 into the drive mechanism 130 produces a multiple cycling of the pin 141, wherein a cycle comprises a push and a pull of a pin into a flow tube 111.

It should be noted that the drive mechanism 130 can be contained within the mold 100. That is, the mold 100 does not require large, press-mounted pistons mounted externally to the mold. The piston 131 is internal to the mold 100 and allows the drive mechanism 130 to be internal to the mold 100 and part of the clamping system within the mold. Recall, the mold 100 consists of cavity sections that can be clamped together during a delivery of the plastic melt. Upon a hardening of the plastic melt, the clamps can be released to remove the plastic melt. Notably, the drive mechanism 130 can be part of the housing of the mold 100 and inside the mold. For example, a portion of the mold 100 can be bored out to create a place for the drive mechanism 130. The drive shaft 133 with the piston 131 and corresponding pin 141 can then be inserted within the drive mechanism 130.

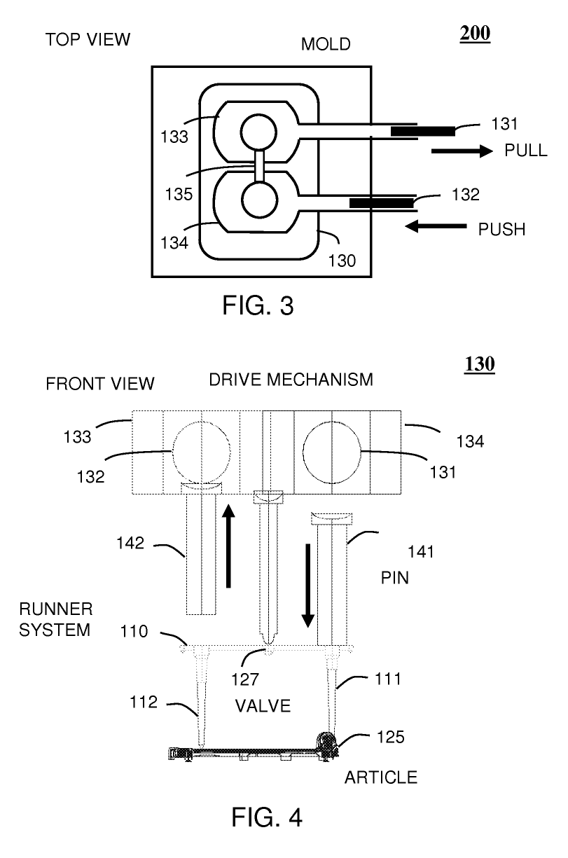

Referring to FIG. 3, a top view of a plastic injection mold 200 having dual drive shafts is shown, herein termed mold 200. The mold 200 can include a first drive shaft 133 operated by a first piston 131 and a second drive shaft 134 operated by a second piston 132. Notably, more or less than the number of drive shafts can be included for providing equal mixing at one or more locations in the cavity 120. The first drive shaft 131 and the second drive shaft 134 can be hydraulic operated. In such regard, a movement of a piston into or out of a drive shaft can cause a movement of a pin to mix a plastic melt in a cavity as shown in FIG. 1. The mold 200 also includes a constraining mechanism 135 operatively coupled to the first piston and the second piston that constrains the first piston 131 to move out-of-phase with the second piston 132. That is, in practice, the first piston 131 moves in an opposite direction of the second piston 132.

Referring to FIG. 4, a front view of the mold 200 is shown. The drive mechanism 130 shows the first drive shaft 133 on the right and the second drive shaft 134 on the left. Due to the constraining mechanism 135 (See FIG. 3), a first pin 141 and a second pin 142 operate out-of-phase with one another to mix the plastic melt in the cavity 120. During a first time, a movement of the first piston 131 pushes a first pin 141 in a first flow tube 111 to push out the plastic melt through the first flow tube 111 to the cavity 120. During the same first time, a movement of the second piston 132 pulls a second pin 142 in a second flow tube 112 to pull in plastic melt from the cavity 120. The first piston 131 and the second piston 132 alternate between pushing and pulling such that the plastic melt moves into and out of the first flow tube 111 and the second flow tube 112 to mix the plastic melt in accordance with the first piston movement and the second piston movement.

The mold 200 also includes a runner valve 127 operatively connected to the runner system 110 to limit a delivery of the plastic melt into a flow tube during operation of the drive mechanism 130. For example, during an injection molding of an article 125, the runner system 110 (See FIG. 1) delivers plastic melt to the cavity 120 through the first flow tube 111 and the second flow tube 112. Upon filling the cavity 120, the drive mechanism 130 operates the first piston 131 and second piston in opposite motion to drive the first pin 141 and the second pin 142 out-of-phase. The runner valve 127 can be shut off to prevent additional plastic melt from being delivered to the cavity 120. The runner valve 127 can also be turned on to introduce different plastic melts. For example, a first plastic melt can be introduced at a first time, followed by a second plastic melt at a second time. The drive mechanism 130 can regulate the flow of plastic melt to the cavity 120 prior to mixing.

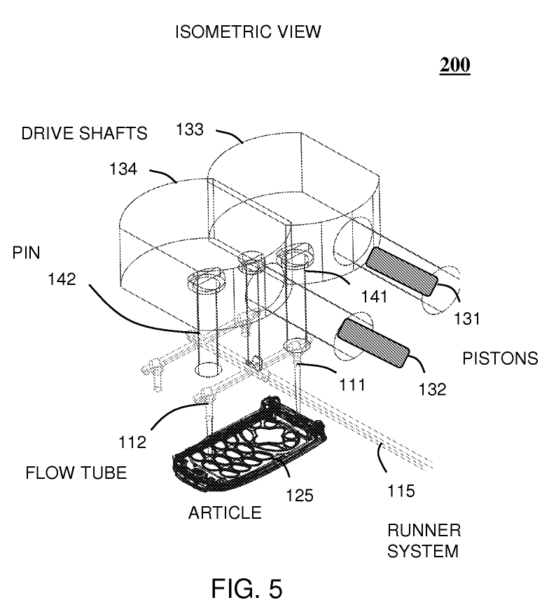

Referring to FIG. 5, an isometric view of the mold 200 is shown. In particular, the drive mechanism 130 including the first drive shaft 133 and the second drive shaft 134, and the runner system 110 are internal to the mold 200. The runner system 110 also includes the first flow tube 111 and the second flow tube 112. It should be noted that a cavity structure of the drive mechanism 130 and a cavity structure of the runner system are integrated within the mold. That is, the mold 200 can include hollowed out cavities for the drive mechanism 130 and the runner system 110. For example, the mold 200 can be bored out to create a cavity structure for the drive shaft 130, and also bored out to create a channel structure for the runner system 110. The channel structure provides conduits for delivering and removing hydraulic fluid. A first pin 141 can be placed in the first flow tube 111, the drive shaft 133 can be filled with hydraulic fluid, and the first piston 131 can be placed in the drive shaft 133 to seal the drive mechanism 130. Similarly, the second pin 142 can be placed in the second flow tube 112, the drive shaft 134 can be filled with hydraulic fluid, and the second piston 132 can be placed in the drive shaft 134 to seal the drive mechanism 130. Plastic melt can be delivered to the cavity through the runner system 110 to produce the article 125. Notably, the article 125 is within the cavity though the dimensions of the cavity are not shown. Recall, the drive mechanism 130 moves the first pin 141 within the first flow tube 111 out-of-phase with the second pin 142 with the second flow tube 112 to mix the plastic melt. In particular, the first flow tube 111 pulls in plastic melt as the first pin 111 ascends, and the second flow tube pushes out plastic melt as the second pin 112 descends due to the opposite movements of the first piston 131 and second piston 132.

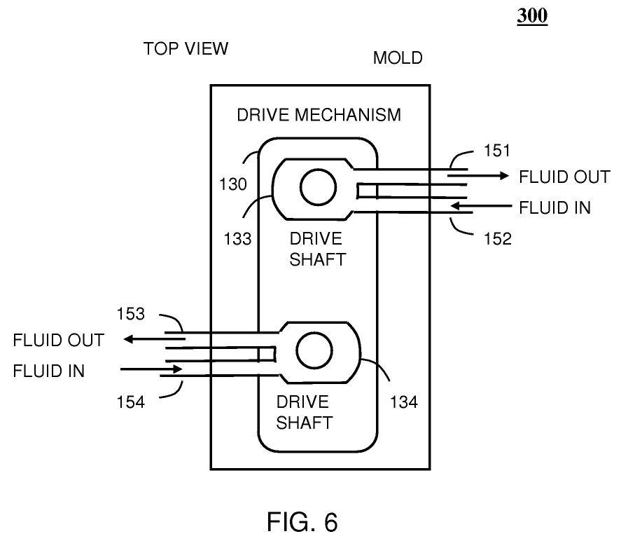

Referring to FIG. 6, another embodiment of the plastic injection mold apparatus is shown, herein termed mold 300. In particular, a first hydraulic pipe 151 and a second hydraulic pipe 152 replace the piston 131 mechanism of FIG. 3. The first hydraulic pipe 151 and the second hydraulic pipe 152 can be sufficiently small to feed into the drive mechanism 130 through the mold 100. Hydraulic fluid can be fed into or taken out of the drive shaft 133 via the pipes. The hydraulic drive mechanism 130 can adjust the amount of hydraulic fluid removed through the first hydraulic pipe 151, and delivered from the second hydraulic pipe 152. In such regard, the hydraulic drive mechanism 130 can be considered a hydraulic pump. In this embodiment, the drive mechanism 130 is hydraulic operated, and not piston operated. This can be advantageous when the size of the drive shaft does not accommodate a large piston diameter. Notably, an increase or decrease of hydraulic fluid in the drive shaft 133 adjusts the movement of the pin 141 (See FIG. 1). In such regard, the drive shaft 133 uses hydraulics to move the pin 141 and mix the plastic melt in the cavity 120.

Similarly, the second drive shaft 134 includes a first hydraulic pipe 153 and a second hydraulic pipe 154. The hydraulic drive mechanism 130 can remove hydraulic fluid from the second drive shaft 134 via the first hydraulic pipe 153, and deliver hydraulic fluid to the drive shaft 134 via the second hydraulic pipe 154. Notably, the first hydraulic pipe 153 and the second hydraulic pipe 153 can be sufficiently small to fit within the mold 300. In such regard, the mold 300 can be bored out to create channels for the pipes. Moreover, the channels in the mold themselves may serve as the conduits to deliver the hydraulic fluid to the drive shafts. Furthermore, a diameter of a hydraulic pipe can be smaller than a diameter of a corresponding flow tube. The size of the pipes are not restricted to being larger than a size of the flow tubes. Notably, more or less hydraulic fluid can be delivered or removed from a drive shaft to move a corresponding pin.

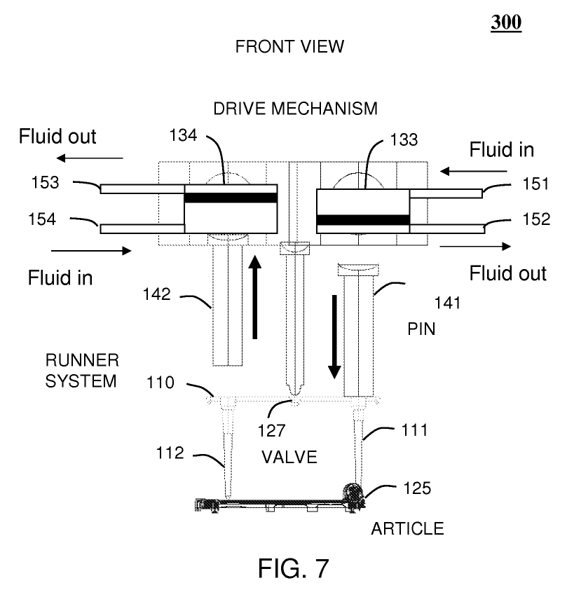

Referring to FIG. 7, a front view of the mold 300 is shown. The drive mechanism 130 shows the first drive shaft 133 on the right and the second drive shaft 134 on the left. The drive mechanism 130 regulates the flow of hydraulic fluid into and out of the drive shafts. In particular, an equal amount of hydraulic fluid is either removed or delivered for each of the drive shafts. Moreover, the delivery and removal of hydraulic fluid is synchronized between the first drive shaft 133 and the second drive shaft. This ensures that the first pin 141 and the second pin 142 move out-of-phase with one another to mix the plastic melt in the cavity 120. For example, at a first time, a specific amount of fluid is delivered to the first drive shaft 133 through the first hydraulic pipe 151. In response, the first pin 141 descends and pushes out the plastic melt through the first flow tube 111 to the cavity 120. The same specific amount is removed from the second drive shaft 134 through the first hydraulic pipe 153. In response, the second pin 142 ascends and pulls in plastic melt through the first flow tube 111 from the cavity 120. At a second time, a specific amount of fluid is removed from the first drive shaft 133 through the second hydraulic pipe 152. In response, the first pin 141 ascends and pulls in plastic melt from the cavity through the first flow tube 111. The same specific amount is delivered to the second drive shaft 134 through the second hydraulic pipe 154. In response, the second pin 142 descends and pushes out plastic melt through the first flow tube 111 to the cavity 120. The hydraulic drive mechanism 130 can repeat the cycle to mix the plastic melt in the cavity. Notably, the hydraulic drive mechanism 130 regulates the flow of hydraulic fluid into and out of the first drive shaft 133 and the second drive shaft 134 to produce an out of phase movement of the first pin 141 and the second pin 142. That is, the first pin 141 ascends while the second pin 142 descends, and the first pin 141 descends while the second pin 142 ascends.

The mold 200 also includes the runner valve 127 operatively connected to the runner system 110 to limit a delivery of the plastic melt into a flow tube during operation of the drive mechanism 130. For example, during an injection molding of an article 125, the runner system 110 (See FIG. 1) delivers plastic melt to the cavity 120 through the first flow tube 111 and the second flow tube 112. Upon filling the cavity 120, hydraulic fluid can be removed or delivered to the drive shafts 133 and 134 in equal proportion to drive the first pin 141 out of phase with the second pin 142. The runner valve 127 can be shut off to prevent additional plastic melt from being delivered to the cavity 120. The runner valve 127 can also be turned on to introduce different plastic melts. For example, a first plastic melt can be introduced at a first time, followed by a second plastic melt at a second time.

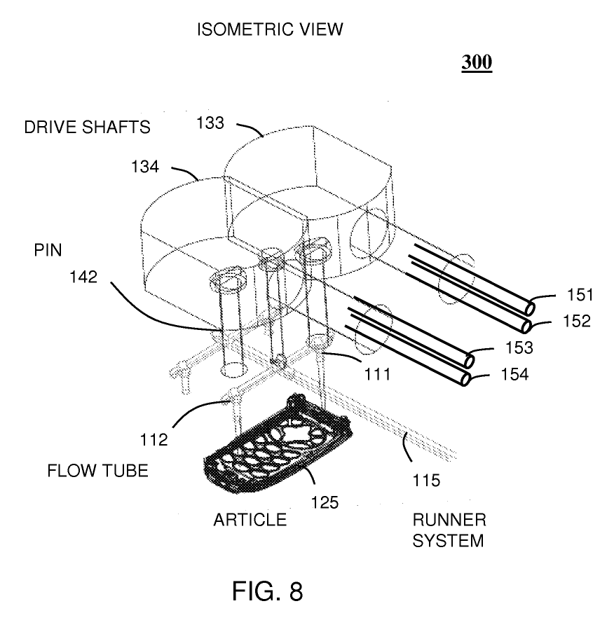

Referring to FIG. 8, an isometric view of the mold 300 is shown. In particular, hydraulic pipes are introduced to adjust the level of hydraulic fluid in a drive shaft. For example, the first drive shaft 133 includes the first hydraulic pipe 151 for delivering hydraulic fluid, and the second hydraulic pipe 152 for removing hydraulic fluid. Similarly, the second drive shaft 134 includes the first hydraulic pipe 153 for removing hydraulic fluid, and the second hydraulic pipe 154 for delivering hydraulic fluid. In such regard, a control of the pins in the flow tubes can be regulated by the amount of hydraulic fluid delivered or removed via the hydraulic pipes to the drive shaft. Moreover, the flow can be controlled to cause the first pin 141 and second pin 142 to move out-of-phase with one another for mixing the plastic melt in the cavity 120 (See FIG. 7).

The drive mechanism 130, including the first drive shaft 133 and the second drive shaft 134, and the runner system 110 are internal to the mold 300. The runner system 110 also includes the first flow tube 111 and the second flow tube 112. It should be noted that a cavity structure of the drive mechanism 130 and a cavity structure of the runner system are integrated within the mold. That is, the mold 300 can include hollowed out cavities or bored out channels for the drive mechanism 130 and the runner system 110. For example, the mold 300 can be bored out to create a cavity structure for the drive shaft 130, and also bored out to create a channel structure for the runner system 110. The channel structure provides conduits for delivering and removing hydraulic fluid to the drive shafts. Notably, the article 125 is within the cavity though the aspects of the cavity are not shown. Recall, the hydraulic drive mechanism 130 moves the first pin 141 within the first flow tube 111 out-of-phase with the second pin 142 with the second flow tube 112 to mix the plastic melt in accordance with the amount of hydraulic fluid delivered or removed from the drive shafts. In particular, the first flow tube 111 pulls in plastic melt as the first pin 111 ascends, and the second flow tube pushes out plastic melt as the second pin 112 descends due to the opposite movements of the first piston 131 and second piston 132.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A plastic mold injection apparatus, comprising
a runner system that delivers a plastic melt through at least one flow tube;
a cavity directly coupled to the runner system that receives the plastic melt, wherein a shape of the cavity produces a plastic molded article from the plastic melt; and
a drive mechanism that interfaces to the runner system and pushes and pulls at least one pin in and out of at least one flow tube of the runner system,
wherein the runner system, the cavity, and the drive mechanism are inside the plastic mold injection apparatus, and a pushing and a pulling of the at least one pin mixes the plastic melt in the cavity.

2. The plastic mold injection apparatus of claim 1, wherein the drive mechanism includes:
at least one piston that moves into and out of the drive mechanism;
a drive shaft that receives the at least one piston; and
at least one pin connected to the drive shaft, wherein the at least one pin moves into and out of the at least one flow tube in accordance with a movement of the at least one piston into and out of the drive shaft.

3. The plastic mold injection apparatus of claim 1, wherein the drive mechanism is a hydraulic pump having a first pipe for removing hydraulic fluid and a second pipe for providing hydraulic fluid such that the pin moves up and down in accordance with a flow of hydraulic fluid into and out of the drive mechanism.

4. The plastic mold injection apparatus of claim 2, wherein the drive mechanism includes:
a first piston that pushes a first pin in a first flow tube to push out the plastic melt through the first flow tube to the cavity; and
a second piston that pulls a second pin in a second flow tube to pull in the plastic melt from the cavity,
wherein the first piston and the second piston alternate between pushing and pulling such that the plastic melt moves into and out of the first flow tube and the second flow tube to mix the plastic melt in accordance with a first piston movement and a second piston movement.

5. The plastic mold injection apparatus of claim 2, further comprising:
a runner valve operatively connected to the runner system that limits a delivery of the plastic melt into the at least one flow tube during operation of the drive mechanism.

6. The plastic mold injection apparatus of claim 2, further comprising a constraining mechanism operatively coupled to the first piston and the second piston that constrains the first piston to move out of phase with the second piston.

7. The plastic mold injection apparatus of claim 2, wherein a movement of the at least one piston into and out of the drive shaft causes the at least one pin to ascend or descend in the cavity to mix the melt.

8. The plastic mold injection apparatus of claim 2, wherein a first movement of a piston into the drive mechanism produces a multiple cycling of a corresponding pin, wherein a cycle comprises a push and a pull of a pin into a flow tube.

9. The plastic mold injection apparatus of claim 2, wherein a flow tube is a bored channel of the plastic mold injection apparatus.

10. A plastic mold injection apparatus, comprising
a runner system that delivers a plastic melt through at least one flow tube;
a cavity directly coupled to the runner system that receives the plastic melt, wherein a shape of the cavity produces a plastic molded article; and
a hydraulic drive mechanism that drives at least one pin in and out of at least one flow tube of the runner system in accordance with a piston movement,
wherein the runner system, the cavity, and the hydraulic drive mechanism operate internal to, and within, the plastic mold injection apparatus, to mix the plastic melt in the cavity.

11. The plastic mold injection apparatus of claim 1, wherein the hydraulic drive mechanism is a hydraulic pump having a first hydraulic pipe for removing hydraulic fluid and a second hydraulic pipe for providing hydraulic fluid such that the pin moves up and down in accordance with a flow of the hydraulic fluid.

12. The plastic mold injection apparatus of claim 11, wherein removing hydraulic fluid from the first pipe drives a first pin in a first flow tube to pull in plastic melt from the cavity, and providing hydraulic fluid in the second pipe drives a second pin in a second flow tube to push out plastic into the cavity.

13. The plastic mold injection apparatus of claim 11, wherein the hydraulic pump produces an out of phase movement of the first pin and the second pin.

14. The plastic mold injection apparatus of claim 11, wherein the hydraulic pump causes the first pin and the second pin to drive out of phase with one another such that the first pin ascends into the first flow tube when the second pin descends from the second flow tube, and the first pin descends from the first flow tube when the second pin ascends in the second flow tube.

15. The plastic mold injection apparatus of claim 11, wherein the hydraulic pump produces a multiple cycling of a corresponding pin, wherein a cycle comprises a push and a pull of a pin into a flow tube.

16. The plastic mold injection apparatus of claim 11, further comprising a runner valve operatively coupled to the drive mechanism that adjusts a delivery of the plastic melt.

17. A method for plastic mold injection, comprising
delivering a plastic melt through at least one flow tube of a runner system in a plastic mold injection apparatus;
receiving the plastic melt in a cavity directly coupled to the runner system, wherein a shape of the cavity produces a plastic molded article; and
pushing and pulling at least one pin in and out of a flow tube of the runner system to mix the plastic melt in the cavity using a hydraulic operated drive mechanism integrated within the plastic mold injection apparatus,
wherein the runner system, the cavity, and the hydraulic operated drive mechanism are internal to the plastic mold injection apparatus.

18. The method of claim 17, further comprising:
delivering hydraulic fluid using a first drive shaft having a first hydraulic pipe and removing hydraulic fluid through a second hydraulic pipe; and
delivering hydraulic fluid using a second drive shaft having a third hydraulic pipe and removing hydraulic fluid through a fourth hydraulic pipe.

19. The method of claim 17, further comprising:
In the first drive shaft, moving a first pin in accordance with a flow of hydraulic fluid into the first drive shaft, and in the second drive shaft, moving a second pin in accordance with a flow of hydraulic fluid into the first drive shaft, such that the first pin moves out-of-phase with the second pin.

20. The plastic mold injection apparatus of claim 17, further comprising:
pulling plastic melt in from the cavity into a first flow tube during an ascending movement; and
pushing out plastic melt from a second flow tube during a descending movement to mix the plastic melt in the cavity.
